(19) United States
(12) Patent Application Publication
(10) Pub. No.: US 2024/0343621 A1
(43) Pub. Date: Oct. 17, 2024

(54) WASTEWATER TREATMENT USING AEROBIC TREATMENT WITH BRUSHITE PRECIPITATION AND RECIRCULATION

(71) Applicant: Centrifuge-Systems LLC, Kenosha, WI (US)

(72) Inventor: Hiroko Yoshida, Kenosha, WI (US)

(21) Appl. No.: 18/609,480

(22) Filed: Mar. 19, 2024

Related U.S. Application Data
(60) Provisional application No. 63/491,885, filed on Mar. 23, 2023.

(51) Int. Cl. C02F 3/12; C02F 1/52; C02F 11/147; C02F 101/10

(52) U.S. Cl. CPC C02F 3/1215; C02F 1/5245; C02F 11/147; C02F 2101/105; C02F 2301/046

(57) ABSTRACT

Systems and methods for use in wastewater treatment plants that use aerobic digestion are provided. The systems and methods precipitate phosphates from the supernatant of an aerobic digest to produce a brushite-containing sludge, at least a portion of which is recirculated back into the aerobic digest. The methods reduce phosphate in the reject water produced by dewatering an aerobic digestate, while maintaining the pH of the aerobically digested sludge in a suitable range for polymer flocculants commonly used in sludge dewatering.

### CROSS REFERENCE TO RELATED APPLICATIONS

The present application claims priority to U.S. provisional patent application No. 63/491,885 that was filed Mar. 23, 2023, the entire contents of which are incorporated herein by reference.

### BACKGROUND

Phosphorus is a common nutrient and contaminant in residential, commercial, and agricultural wastewater streams. Unfortunately, phosphorus can be difficult to remove during wastewater treatment and, therefore, becomes a nuisance. Sewage treatments plants are required to reduce phosphorus levels in discharge water to low levels and this is typically accomplished by directing the phosphorus to the sewage sludge, or biosolids, which are usually land applied. During wastewater treatment, the phosphorus level in the sludge can climb to levels at which phosphate and multivalent cations in the wastewater form precipitates. However, once the multivalent cations are depleted, high levels of phosphates remain in the soluble form and recirculate within the plant. Therefore, phosphate removal is desirable to reduce the phosphorus loading in the wastewater treatment process and to lower the phosphorus discharge from the wastewater treatment plant

Aerobic digestion is a process that is used in some wastewater treatment facilities. During aerobic digestion organic solids in the wastewater are digested by aerobic microbes in an oxygen-containing environment and CO₂ is released. Aerobic digestion has the potential to digest organic solids at a much faster rate than anaerobic digestion. However, aerobic digests tend to be acidic due to the microbial oxidation of ammonium released from the digested organics to the nitrate form (i.e., nitrification):

NH₄⁺+3/2 O₂→NO₃⁻+2H⁺.

The production of acidity by nitrification will consume alkalinity in the aerobic digest and leaves the digest with little or no weak acid buffer. As a result, aerobic digests have an acidic pH, which results in the dissolution of calcium phosphates naturally occurring in the wastewater and sludge treatment process. This results in relatively high concentrations of soluble orthophosphates in the aerobic digest. This is particularly problematic if the starting material for aerobic digestion has a high phosphate content, such as a sludge produced from enhanced biological phosphorus recovery (EBPR). Soluble phosphates can be removed from an aerobic digestate by solid/liquid separation. Due to low alkalinity of the aerobic digest stream, many conventional options for phosphate removal cannot be used without adding an alkali chemical to adjust pH.

FIG. 1A illustrates a simple sewage sludge 100 treatment process using an acrobic reactor, such as an aerobic digester, 102, to produce an acrobically treated sludge 103 (a treated sludge), that is separated into a high-solids “cake” 107 containing precipitated phosphates and a liquid effluent (liquid stream 108) using a dewatering unit 106.

### SUMMARY

Methods of removing soluble phosphates from an acrobically treated sludge are provided. The methods include the steps of: (a) producing an acrobically treated sludge comprising dissolved phosphates in an acrobic reactor; (b) dewatering the aerobically treated sludge to form a dewatered cake comprising precipitated phosphates and other solids and a liquid fraction comprising dissolved phosphates; (c) adding a calcium phosphate precipitating agent to the liquid fraction to increase the pH of the liquid fraction and precipitate phosphates, including brushite; (d) separating the liquid fraction into a calcium phosphate fraction comprising the precipitated phosphates, including brushite, and other residual solids and a liquid effluent; (c) recirculating at least a portion of the calcium phosphate fraction back into the acrobically treated sludge to form a mixed sludge that is saturated in calcium phosphate; (f) adding a polymer flocculant to the mixed sludge; and (g) dewatering the mixed sludge to form additional dewatered cake comprising precipitated phosphates and other solids.

### BRIEF DESCRIPTION OF THE DRAWINGS

Illustrative embodiments of the invention will hereafter be described with reference to the accompanying drawings, wherein like numerals denote like elements.

FIG. 1A is a flow chart showing a wastewater treatment process using aerobic digestion without phosphate precipitation and recirculation.

FIG. 1B is a flow chart showing a wastewater treatment process using an aerobic treatment process with phosphate precipitation and recirculation.

FIG. 2 shows the effect of pH level on orthophosphate concentration in an aerobically treated sludge and reject water derived therefrom, in accordance with the Example.

FIG. 3 shows the processing parameters and the solids and phosphorus content for an acrobically treated sludge, reject water, and solids cake derived from the process shown in FIGS. 1A-1B, in accordance with the Example.

FIGS. 4A and 4B show the processing parameters and the solids and phosphorus content for the various sludges, reject water, and a solids cake derived from the process shown in FIG. 2, in accordance with the Example.

### DETAILED DESCRIPTION

Systems and methods for use in wastewater treatment plants that use an aerobic sludge treatment process are provided. The systems and methods precipitate phosphates from the supernatant of an acrobically treated sludge to produce a brushite-containing sludge, at least a portion of which is back mixed into the aerobic digest in a mixing tank located upstream of a sludge dewatering unit. The methods maintain the pH of the sludge entering the dewatering unit in a range at which polymer flocculants can perform effectively. In some instances, the methods can also increase the dewaterability of the sludge and increase the total solids content in biosolids derived from the sludge.

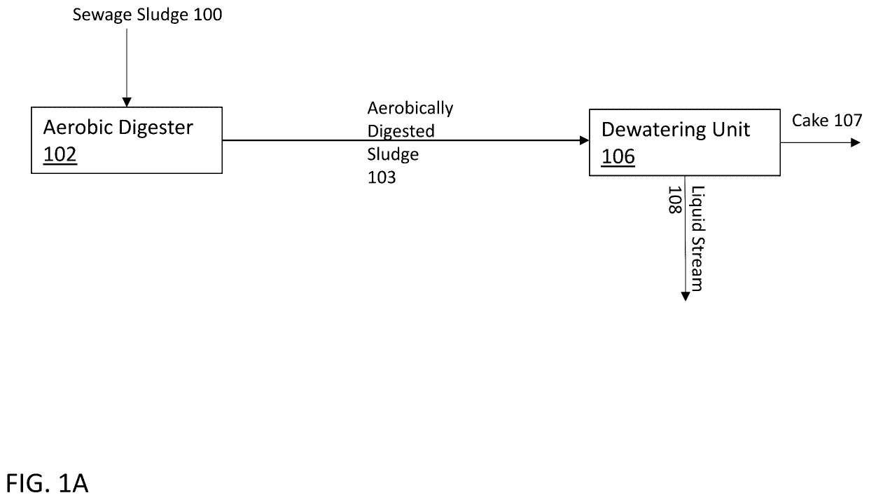

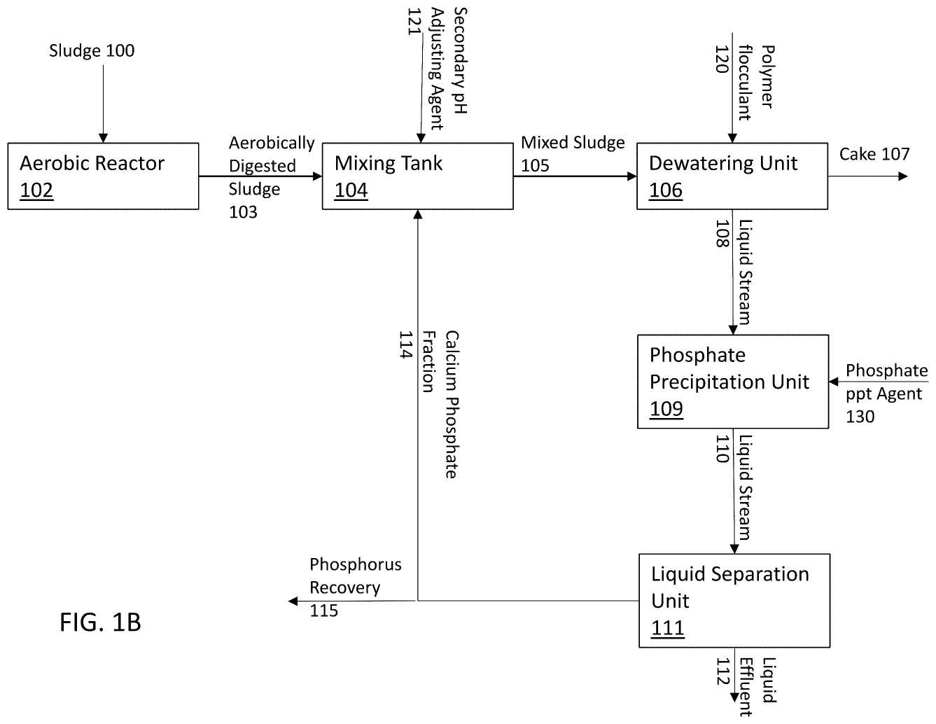

An illustrative embodiment of a method for treating wastewater using aerobic digestion with phosphate precipitation and recirculation is shown in the flow chart of FIG. 1B. In the methods, a sewage sludge 100 is fed into an aerobic reactor (e.g., digester) 102. Sewage sludge 100 will generally include at least some raw sewage from which grit and any large objects have been removed (primary sludge), but may also include sewage sludge that has undergone additional pretreatment. For example, sewage sludge 100 may include at least some sludge from a biological treatment process. Examples of sewage sludges with a particularly high accumulation of phosphates are those formed by an enhanced biological phosphorus removal (EBPR) process. During the EBPR process, polyphosphate accumulating organisms (PPAOs) have accumulated polyphosphate as an energy storage compound in their biomass in addition to the normal physiological phosphorus used by all organisms. As an alternative to EBPR sludge, some anaerobically treated sludges can be used as sewage sludge 100. Anaerobically treated sludges contain high levels of acid-releasable phosphorus that can be released by an aerobic treatment.

In aerobic reactor 102, sewage sludge 100 is agitated with air or oxygen for a period of time in the presence of aerobic bacteria that feed on the sludge and produce carbon dioxide. The time duration and temperature of the aerobic digestion will vary from treatment plant to treatment plant. By way of illustration only, typical aerobic digestion times are in the range from about 40 days to 60 days and typical aerobic digestion temperatures are in the range from 15° C. to 20° C. However, times and/or temperatures outside of these ranges can be used.

The effluent of aerobic digester is an aerobic digest or, as it is referred to herein, an Acrobically Treated Sludge 103. Acrobically Treated Sludge 103 is primarily water, but has a significant solids content. The aerobically treated sludge from an aerobic reactor is typically slightly acidic, usually having pH above 6 but less than 7.

Acrobically Treated Sludge 103 contains phosphates, and those phosphates are highly soluble in the acidic environment of the aerobic digest, which is acidified by the oxidation of ammonium and the production of H⁺ ions. Therefore, high levels of phosphates are present in Acrobically Treated Sludge 103. Most of these take the form of orthophosphates.

Precipitated phosphates in Acrobically Treated Sludge 103 can be removed from Acrobically Treated Sludge 103 by dewatering, which separates the sludge into a biosolids fraction (Cake 107) and a liquid fraction (also referred to as reject water). This process is often assisted with the use of polymer flocculants that form flocs with suspended phosphorous precipitates and other suspended solids so that they settle out of solution and can be removed as part of the biosolids. However, phosphates that remain solubilized are not removed with the biosolids, and some of the fine precipitated phosphate particles can even be retained in the liquid fraction after dewatering. In most conventional wastewater treatment systems, this uncaptured soluble and fine particulate phosphorus is recirculated back to the head of the wastewater treatment plant, thereby increasing the pressure on the wastewater treatment stream to meet phosphorus discharge limits. In contrast, the methods and systems described herein enable these phosphates to be removed from the liquid fraction using precipitating agents with precise dosing control.

Precise dosing control is achieved by maintaining the calcium phosphate concentration of the sludge entering the dewatering unit at saturation levels such that the soluble phosphate level in the liquid fraction from the dewatering unit may be determined by pH alone. The ability to achieve precise dosing control is particularly advantageous for aerobic digests, which lack the strong buffering that is present in organic acid digests.

The calcium phosphate saturation conditions are achieved by using a phosphate precipitation unit in combination with back mixing of precipitated phosphates into the aerobic digest at a location upstream of a sludge dewatering unit. This is shown in FIG. 1B, where the liquid stream 108 produced by the dewatering of Acrobically Digested Sludge 103 is fed into a phosphate precipitation unit 109. A phosphate precipitating agent 130 is then dosed into (added to) liquid stream 108, and calcium phosphates, including brushite, are precipitated out of solution. The phosphate (e.g., brushite) precipitating agents 130 are basic, calcium-containing inorganic compounds, such as calcium hydroxide (slaked lime), calcium carbonate, calcium oxide (lime), or a mixture of two or more thereof. In its simplest form, phosphate precipitation unit 109 can be a chamber with one or more ports for introducing liquid stream 108 and phosphate precipitating agent 130 and for expelling the resulting mixture as a liquid output 110. The phosphate precipitation unit may optionally include a mixer or agitator.

The phosphates are precipitated in phosphate precipitation unit 109 as brushite, a calcium phosphate mineral having the formula CaHPO₄·2H₂O, and, optionally, other calcium phosphates, by increasing the pH of the liquid to neutral or a slightly basic value through the addition of the phosphate precipitating agent 130. The range of “neutral to slightly basic” means pH values in the range from 7.0 to 8.0, including 7.0 to 7.5. Increasing the pH to around 7.0 is advantageous because that favors brushite formation. The higher pH conditions can also be used, although at higher pH other calcium phosphate minerals with somewhat slower precipitation kinetics, but with lower solubility, such as octacalcium phosphate, can form. Thus, by increasing the pH to 7.0 or close to 7.0, the solubilized phosphates can be precipitated primarily as brushite. For example, in various embodiments of the methods, at least 50 wt. %, at least 80 wt. %, at least 90 wt. %, or at least 98 wt. % of the precipitated phosphates are brushite.

A challenge to accurately controlling the dosing of the phosphate precipitating agent 130 needed to precipitate out the calcium phosphates is that the soluble phosphate concentration in Acrobically Digested Sludge 103 is variable and unpredictable and depends on background soluble calcium as well as pH. Therefore, the soluble phosphate concentration in liquid stream 108 would also be variable and unpredictable. The present wastewater treatment methods address this problem by recirculating at least a portion of the precipitated calcium phosphates, including brushite, back into a Mixing Tank 104 located upstream of a sludge Dewatering Unit 106. In Mixing Tank 104, incoming Acrobically Digested Sludge 103 is mixed with the recirculated precipitated calcium phosphates to increase the calcium phosphate concentration in the resulting Mixed Sludge 105 to a saturation level. As a result, solubilized phosphate concentration in liquid stream 108 exiting Dewatering Unit 106 is stabilized because the phosphate concentration is determined solely by, or primarily by, its solubility constant at a given pH. This stabilization of the phosphate concentration in liquid stream 108 makes it possible to assess and precisely control the amount (dose) of phosphate precipitating agent needed to precipitate calcium phosphates in phosphate precipitation unit 109.

Typically, the liquid output 110 from phosphate precipitation unit 109, which contains the precipitated calcium phosphates along with any other precipitated phosphate compounds and residual solids, undergoes a liquid/solid separation in a liquid separation unit 111 before precipitated calcium phosphates are fed into Mixing Tank 104. In liquid separation unit 111, liquid output 110 is separated into a Calcium Phosphate Fraction 114, which is a sludge containing the precipitated calcium phosphates, and a liquid effluent 112. Liquid separation unit 111 can separate the liquid from the sludge via sedimentation and may include one or more sedimentation tanks (clarifiers). However, other solid/liquid separators, such as a centrifuge, can also be used.

The entire Calcium Phosphate Fraction 114 need not be routed back into Mixing Tank 104. In fact, back-mixing too much of Calcium Phosphate Fraction 114 with Acrobically Treated Sludge 103 may result in conditions of Mixed Sludge 105 that deteriorate the performance of polymer flocculants used in Dewatering Unit 106. Therefore, some of the precipitated calcium phosphates, along with other precipitated phosphates and residual solids, may be extracted from (recovered) Calcium Phosphate Fraction 114 before it is fed into Mixing Tank 104 (shown as Phosphorus Recovery 115 in FIG. 1B).

The polymer flocculants 120 are added to Mixed Sludge 105 before or during the dewatering process in order to flocculate suspended solids, including precipitated brushite particles, to facilitate their settling and removal. Suitable polymer flocculants include, but are not limited to, cationic polymers, such as cationic polyacrylamides. In some embodiments of the present systems and methods, Dewatering Unit 106 includes or consists of a belt press that presses Mixed Sludge 105 against a permeable belt to force the liquid through the belt (as liquid stream 108) and capture the solids (as Cake 107). However, other solid/liquid separators, such as other types of presses (e.g., a screw press or filter press) or a centrifuge, can also be used for dewatering.

Optionally, a secondary pH adjusting agent 121 may be added to Mixing Tank 104 to maintain the pH of Mixed Sludge 105 in a workable or optimal range for the polymer flocculant. This use of secondary pH adjusting agent 121 may be desirable because Mixed Sludge 105 generally has a higher pH (lower acidity) than Acrobically Digested Sludge 103, due to the dissolution of the calcium phosphates from Calcium Phosphate Fraction 114. By way of illustration only, Acrobically Digested Sludge 103 having a pH in the range from 4.4 to 6.8 can be mixed with Calcium Phosphate Fraction 114 to produce Mixed Sludge 105 having a pH in the range from 6.5 to 7.5. In situations where the dissolution of calcium phosphates from Calcium Phosphate Fraction 114 increases the pH of Mixed Sludge 105 to a value at which the flocculating action of the polymer is degraded, a secondary pH adjusting agent 121 can be added to reduce the pH. The amount of secondary pH adjusting agent 121 added will depend on the particular polymer flocculant being used. For example, cationic polymer flocculants typically have effective operating pH ranges of about 4 to about 8, and in some cases about 5 to about 7. Therefore, the amount of secondary pH adjusting agent could be selected to maintain the pH of Mixed Sludge 105 with these ranges. In some illustrative and non-limiting embodiments of the methods, the amount of secondary pH adjusting agent added is sufficient to produce phosphate concentration of at least 150 ppm in Mixed Sludge 105.

Another benefit of adding secondary pH adjusting agent 121 to Mixed Sludge 105 is that it can stabilize the pH of the sludge entering Dewatering Unit 106 and, therefore, also stabilize the pH of liquid stream 108. Examples of secondary pH adjusting agents that can be used include inorganic and organic acids, such as sulfuric acids, hydrochloric acid, or volatile fatty acids generated from the hydrolysis of organic matter.

Brushite and other precipitated phosphates that are recirculated will become part of Cake 107 (phosphate sequestration), which may be passed along to additional downstream processing or, if it meets the local regulations for land application, may be land applied as biosolids. Either way, the soluble phosphates are not recycled from the aerobic digest back to the front end of the process, only to be collected again for sludge treatment.

The systems and methods described herein can remove high levels of total solids and soluble phosphates from an aerobically digested sludge in the form of Cake 107. By way of illustration, at least 90 wt. % of total solids and at least 50 wt. % soluble phosphates can be removed from an aerobically digested sludge in Cake 107.

The sludges produced during the various processing steps of the methods described herein may be characterized by relatively low solids contents of less than about 7 weight percent (wt. %) solids-typically in the range from about 1 wt. % to about 5 wt. %. In contrast, the solid cake formed by dewatering a sludge is generally characterized by a solids content of at least 12 wt. % and more typically at least about 15 wt. %. By way of illustration only, Cake 107 may have a solids content in the range from 15 wt. % solids to 30 wt. % solids. Liquid fractions derived by removing water from a sludge to increase the solids content of a sludge typically have a solids content of less than 1 wt. %, including less than 0.5 wt. %, and further including less than 0.1 wt. %.

### EXAMPLE

This Example illustrates a wastewater treatment that utilizes a calcium phosphate back mixing step to optimize polymer flocculant efficiency and enable precise dosing control of a calcium phosphate precipitating agent.

The studies described herein were conducted on two samples. The first sample was the digest stream exiting an aerobic digester (“the Aerobically Digested Sludge”) and the second sample was the pressate obtained from passing the Aerobically Digested Sludge through a belt press (“the Reject Water”).

The Aerobically Digested Sludge and the Reject Water were initially analyzed for total solids (TS), pH, orthophosphate content (“Ortho P”), and total phosphate content (“Total P” or “TP”). The results are reported in Table 1. It was found that 67% and 35% (based on weight) of the Total P were in the soluble and reactive Ortho P form in the Pressate and the Aerobically Digested Sludge, respectively. The remainder was particulate phosphate bound to the solids. Based on the data, it was determined that both the conversion of Ortho P to particulate P and the improvement of solid capture due to improved dewatering of the biosolids reduced the internal recirculation of phosphorus within the plant.

TABLE 1
Characteristics of Samples

| | | | | Total P |
|---|---|---|---|---|
| | | | Ortho P | (Soluble + |
| | | | (Soluble, | Particulate, |
| | % TS | pH | mgP/L) | mgP/L) |
| Reject Water | 0.37% | 6.5 | 184 | 274 |
| Aerobically | 1.10% | 6.3 | 162 | 460 |
| Digested Sludge | | | | |

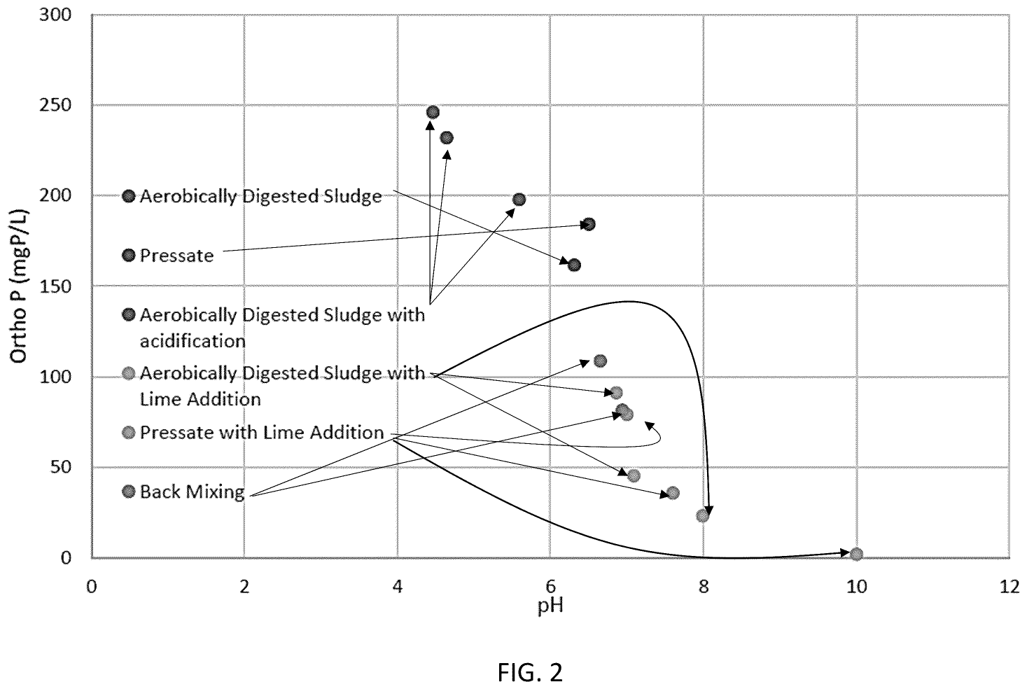

Next, the effect of pH on the Ortho P concentration was studied in the two samples. The pH of the samples was adjusted using a calcium hydroxide slurry (10% w.w) or sulfuric acid (96.2% w.w). As shown in the graph of FIG. 2, there was an almost linear decrease in the Ortho P concentration with increasing pH for both the Aerobically Digested Sludge and the Reject Water up to a pH of 8. Rapid reduction of the Ortho P concentration was observed between a pH of 6 and a pH of 7. The Ortho P concentration dropped below 50 mgP/L above a pH of 7.

The Aerobically Digested Sludge was acidified to evaluate the effect of acidic conditions on the solubilized and precipitated phosphates. While some increase in Ortho P solubilization was observed, an improvement in the downstream dewaterability of the sludge was not observed.

The effect of calcium hydroxide (Ca(OH)₂) addition on the Ortho P concentration was studied at two points in the wastewater treatment process and the results are included in the graph of FIG. 2. In the first study, the calcium hydroxide was added directly to the Aerobically Digested Sludge, and in a second study, the calcium hydroxide was added to the Reject Water. Notably, the Aerobically Digested Sludge was found to have higher buffer capacity than the Reject Water, and it took almost twice as much calcium hydroxide to raise the pH of the Aerobically Digested Sludge, relative to the Reject Water.

Using a clarifier, the Reject Water with added calcium hydroxide was separated into a sludge (Calcium Phosphate Fraction) and a liquid fraction, and the effect of recirculating the Calcium Phosphate Fraction containing the brushite and other residual solids back into the Aerobically Digested Sludge was studied to evaluate its effect on sludge dewatering. The sludge that resulted from the mixture of the Aerobically Digested Sludge and the Calcium Phosphate Fraction is referred to as “the Mixed Sludge.” As shown in the graph of FIG. 2, the Mixed Sludge (“Back Mixing”) had a lower pH and a reduced Ortho P concentration than did the Aerobically Digested Sludge when it exited the aerobic digester.

The results demonstrate that an abundance of background soluble Ca and pH were drivers of the conversion of the solubilized Ortho P into brushite.

Having confirmed suitable pH and calcium hydroxide concentration ranges to achieve sufficient precipitation of Ortho P as calcium phosphates, a settling test was conducted to evaluate the effectiveness of removing precipitated phosphates from the studied samples. It was observed that the addition of calcium hydroxide to increase the pH of the Reject Water reduced the settling speed of the solid, although a settling time of 20-30 min was found to be sufficient. The resulting supernatants appeared to be free of solids, and gravity separation resulted in greater than 90%, based on weight, removal of both biosolids and precipitated phosphorus.

Particulate phosphate settling was achieved in the Aerobically Digested Sludge with the assistance of the cationic polymer flocculant Solenis K275FLX (a high charge polyacrylamide polymer). Diluted polymer flocculant was added to the sludges, which were then belt pressed using a woven mesh belt. Breakthrough of flocculated brushite (“brushite floc”) through the belt and into the Reject Water was observed. The brushite floc settled rather quickly under gravity and was eliminated under elevated G force in a centrifuge. Table 2 summarizes the degree of particulate phosphate removal from the Aerobically Digested Sludge and the Reject Water.

TABLE 2
Summary of Expected Particulate P Removal

| | Solid Liquid | Particulate |
|---|---|---|
| Feed Type | Separation | P removal |
| Aerobically Digested Sludge | Belt Press | 82% |
| Aerobically Digested Sludge | Centrifuge | >90% |
| Reject Water | Plate Settler | >90% |

Finally, a jar test was conducted on the following digested sludge samples to evaluate the change in sludge dewaterability: Aerobically Digested Sludge; Aerobically Digested Sludge with calcium hydroxide addition; Acidified Aerobically Digested Sludge; and Mixed Sludge. For all the sludges, the cationic polymer flocculant was used to enhance solids settling. Several polymer options were tested to determine optimal polymer charge strength and structure. For all sludges, the structured high charge cationic polymer was found to be most effective for forming sheer resistant polymer.

Once the polymer flocculant type and dose to achieve a sheer resistant floc were determined, the achievable solid content of a dewatered cake derived from each digested sludge sample was measured. The results of the dewaterability analysis are summarized in Table 3. The results show that the pH shifted due to the addition of calcium hydroxide, and sludge acidification reduced the dewaterability of the sludge, relative to the initial Aerobically Digested Sludge. However, the Mixed Sludge resulting from the recirculation of the calcium hydroxide-treated Reject Water (i.e., the Calcium Phosphate Fraction) back into the aerobic digest actually increased the dewaterability of the sludge and produced a cake with the higher total solids.

TABLE 3
Summary of the dewaterability test

| | Solid | Polymer Dose | Cake |
|---|---|---|---|
| Feed Type | Capture | (lbs. active/DT) | TS (%) |
| Aerobically Digested Sludge | >90% | 35-45 | 19-21% |
| Aerobically Digested | >90% | 35-45 | 16-17% |
| Sludge with added | | | |
| calcium hydroxide | | | |
| Acidified Aerobically | >90% | 35-45 | 16-17% |
| Digested Sludge | | | |
| Reject Water with | >90% | 35-46 | 20-22% |
| added calcium hydroxide | | | |
| and Aerobically | | | |
| Digested Sludge | | | |

Table 4 summarizes the results of adding calcium hydroxide directly to the Aerobically Digested Sludge versus adding calcium hydroxide to the Reject Water, achieving 66% total solid removal and 90% TS removal by decanter centrifuge.

TABLE 4

| | | | TP level | TP level |
|---|---|---|---|---|
| | | | in side | in side |
| | Ca Dose | | stream at solid | stream at 90% |
| | (Ca:Ortho P | Ortho P | removal rate | TS removal |
| Feed Type | ratio by mol) | removal | (mgP/L) | rate (mgP/L |
| Aerobically | 0.9-1.1 | 82-86% | 137-146 | 67-75 |
| Digested | | | | |
| Sludge | | | | |
| Reject | 0.5-0.6 | 80-85% | 110-135 | 47-72 |
| Water | | | | |

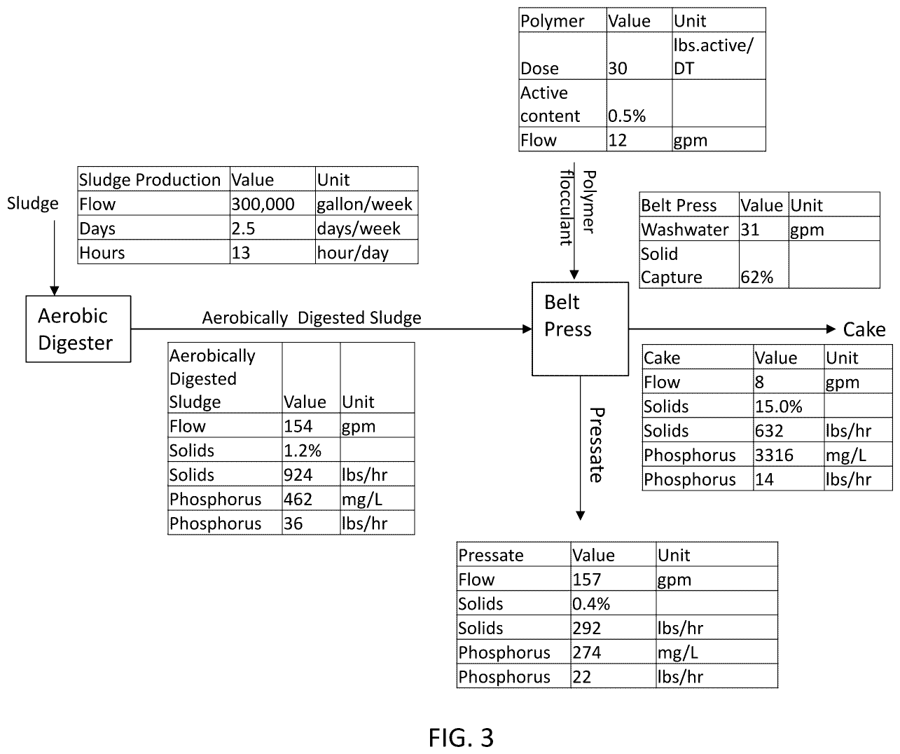

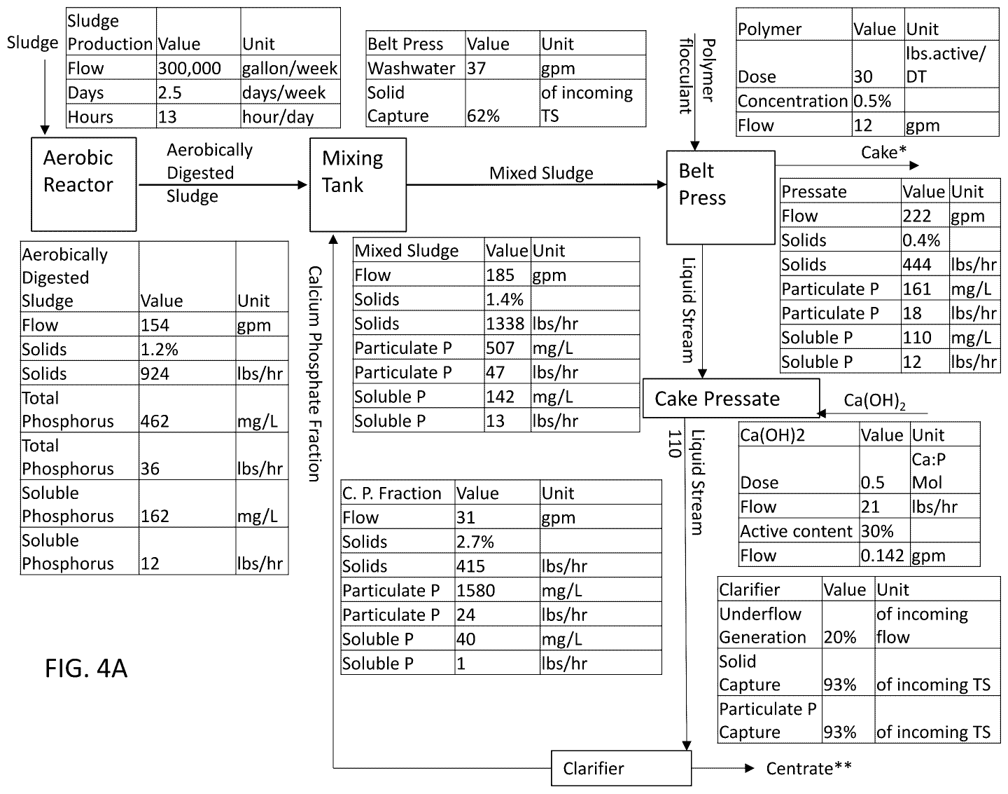

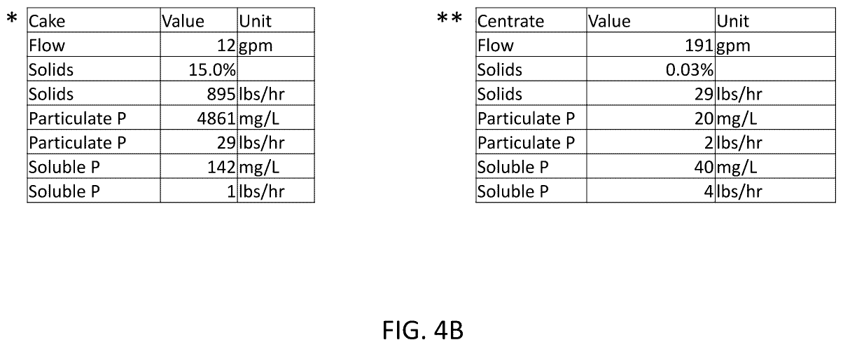

Finally, the mass and phosphorus balance of the wastewater processing scheme of FIG. 1A, using the processing parameters and conditions shown in FIG. 3 and the mass and phosphorus balance of the wastewater processing scheme of FIG. 1B, using the processing parameters and conditions shown in FIGS. 4A and 4B, were evaluated to assess the additional loading on the belt press under a scenario in which approximately 300,000 gal per week of aerobically digested sludge (1-1.4 wt. %) is dewatered 2-3 times/week for 12-14 hrs each time. As shown in FIGS. 3 and 4, an approximately 20% increase in flow and 49% increase in solid loading to the belt press is expected. With the implementation of a calcium-based phosphorus precipitation and removal system on the Reject Water line (FIG. 4A), the solid recirculation is expected to be reduced by 90% and the phosphorus recirculation by 73%.

It should be noted that the processing conditions shown in FIGS. 3 and 4A-4B and the results achieved using these specific processing conditions are for illustrative purposes only.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A method of removing soluble phosphates from an aerobically treated sludge, the method comprising:
(a) producing an aerobically treated sludge comprising dissolved phosphates in an aerobic reactor;
(b) dewatering the aerobically treated sludge to form a dewatered cake comprising precipitated phosphates and other solids and a liquid fraction comprising dissolved phosphates;
(c) adding a calcium phosphate precipitating agent to the liquid fraction to increase the pH of the liquid fraction and precipitate phosphates, including brushite;
(d) separating the liquid fraction into a calcium phosphate fraction comprising the precipitated phosphates, including brushite, and other residual solids and a liquid effluent;
(e) recirculating at least a portion of the calcium phosphate fraction back into the aerobically treated sludge to form a mixed sludge that is saturated in calcium phosphate;
(f) adding a polymer flocculant to the mixed sludge; and
(g) dewatering the mixed sludge to form additional dewatered cake comprising precipitated phosphates and other solids.

2. The method of claim 1, further comprising adding a secondary pH adjusting agent to the mixed sludge to decrease the pH of the mixed sludge.

3. The method of claim 2, wherein the calcium phosphate precipitating agent comprises calcium hydroxide.

4. The method of claim 2, wherein the calcium phosphate precipitating agent consists of calcium hydroxide.

5. The method of claim 1, wherein the calcium phosphate precipitating agent comprises calcium hydroxide.

6. The method of claim 1, wherein the calcium phosphate precipitating agent consists of calcium hydroxide.

7. The method of claim 1, in which the phosphates precipitated by the calcium phosphate precipitating agent have a brushite content of at least 90 wt. %.

8. The method of claim 2, in which the phosphates precipitated by the calcium phosphate precipitating agent have a brushite content of at least 90 wt. %.

9. The method of claim 3, in which the phosphates precipitated by the calcium phosphate precipitating agent have a brushite content of at least 90 wt. %.

10. The method of claim 1, wherein the method removes at least 90 wt. % of total solids and at least 50 wt. % soluble phosphates from the aerobically digested sludge in the additional dewatered cake.

11. The method of claim 2, wherein the method removes at least 90 wt. % of total solids and at least 50 wt. % soluble phosphates from the aerobically digested sludge in the additional dewatered cake.

12. The method of claim 3, wherein the method removes at least 90 wt. % of total solids and at least 50 wt. % soluble phosphates from the aerobically digested sludge in the additional dewatered cake.

13. The method of claim 9, wherein the method removes at least 90 wt. % of total solids and at least 50 wt. % soluble phosphates from the aerobically digested sludge in the additional dewatered cake.
